(19) United States
(12) Patent Application Publication
(10) Pub. No.: US 2009/0287649 A1
(43) Pub. Date: Nov. 19, 2009

(54) METHOD AND APPARATUS FOR PROVIDING CONTENT PLAYLIST

(75) Inventor: Sung-sik PARK, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/266,752

(22) Filed: Nov. 7, 2008

(30) Foreign Application Priority Data
May 14, 2008 (KR) 2008-44727

(51) Int. Cl. G06F 7/06; G06F 17/30

(52) U.S. Cl. 707/3; 707/E17.014

(57) ABSTRACT

A content playlist providing method used in a content playback apparatus storing content, the method including: extracting information of content to be played back from a first content playlist listing the content to be played back; searching stored content based on the extracted information; and creating a second content playlist listing the found items of content. Content that the user wishes to playback can be predicted based on a playlist created by the user, and an expanded playlist can be created based on the predicted content. Thus, the user can create a new, expanded playlist without designating all the content that the user wishes to play back.

### CROSS-REFERENCE TO RELATED APPLICATION

This application claims the benefit of Korean Patent Application No. 2008-44727, filed on May 14, 2008 in the Korean Intellectual Property Office, the disclosure of which is incorporated herein in its entirety by reference.

### BACKGROUND OF THE INVENTION

1. Field of the Invention

Aspects of the present invention relate to a method and apparatus to provide a content playlist, and more particularly, to a method and apparatus to provide an expanded content playlist from a brief content playlist based on a similarity of content information.

2. Description of the Related Art

Due to currently increasing capacities of digital content apparatuses, numerous pieces of content can be stored in content playback apparatuses. However, for portable content playback apparatuses, due to limitations in input and output, selecting content for such devices is becoming more difficult as compared to other apparatuses. Currently, it is possible to search for and classify music files. However, due to a variety of individuals' needs, it is significantly troublesome to classify found music files. Conventional methods provide the simple results of searching for the artist, album, etc., through a simple keyword search. In keyword searching, for example, when “LOVE” is designated and input as a searching keyword, ID3 tags of MP3 files (such as the titles of songs or albums, the names of artists, etc.) are found providing the titles of songs that include the searched keyword “LOVE” as the search results. However, such search results cannot be readily used as a playlist. In general, one of the titles is selected from the search results and played back or is added to a playlist. That is, simple searching using keywords is useful in finding a single title or song from the search results. However, the search results cannot be used directly as a playlist.

### SUMMARY OF THE INVENTION

Aspects of the present invention provide a method and apparatus to provide an expanded content playlist by creating a brief content playlist from a single or multiple items of content designated by a user and obtaining results of a searching for content in an order of similarity to the content listed in the brief content playlist.

According to an aspect of the present invention, there is provided a content playlist providing method in a content playback apparatus storing content, the method including: extracting information of content to be played back from a first content playlist listing content to be played back; searching stored content based on the extracted information; and creating a second content playlist listing content, from among the stored content, found in the searching.

The method may further include creating a first content playlist listing the content to be played back based on the stored content.

If the content to be playedback is an audio file, the information of the content may be a name of the audio file and/or ID3 tag information.

The ID3 tag information may include a title, an artist, an album, a year of release, and/or a genre.

If one item of content is listed in the first content playlist, the searching of the stored content may include searching the stored content based on a similarity between the extracted information and information of the stored content.

If multiple items of content are listed in the first content playlist, the searching of the stored content may include: extracting similar points of the extracted information; and searching the stored content based on a similarity between the similar points and information of the stored content.

The creating of the second content playlist may include creating the second content playlist by arranging the found content in a priority order of highest similarity.

The creating of the second content playlist by arranging the found content in the priority order may include creating the second content playlist by selectively setting the priority order.

The method may further include downloading the first content playlist through a communication network.

If the content playback apparatus is connected to a website that provides content online, the first content playlist may be provided from the website.

The first playlist provided from the website may include content provided from the website.

The content provided from the website may be displayed separately as a list of content purchased by the user and as a list of non-purchased content.

According to another aspect of the present invention, there is provided a content playlist providing apparatus including: a storage unit to store content; an extraction unit extracting information of content to be played back from a first content playlist listing the content to be played back; a search unit to search the content stored in the storage unit based on the extracted information; and a second content playlist creation unit to create a second content playlist listing the found items of content.

According to another aspect of the present invention, there is provided a content playlist providing apparatus including: an extraction unit to extract information of content to be played back from a first content playlist listing the content to be played back; a search unit to search predetermined content based on the extracted information; and a second content playlist creation unit to create a second content playlist listing content, from among the predetermined content, found in the searching.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an example of an ID3 tag of an MP3 file;

FIG. 2 is a block diagram of a content playlist providing apparatus according to an embodiment of the present invention;

FIG. 3 is a table of a first content playlist according to an embodiment of the present invention;

FIG. 4 is a table of a second content playlist according to an embodiment of the present invention; and

FIG. 5 is a flowchart of a content playlist providing method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the present description of embodiments of the present invention, content refers to files that can be reproduced in the form of moving pictures or audio. Content includes information representing various features of each piece of content. For example, content may include information such as the title of content, year of production, etc. An ID3 tag is included in audio files (such as MPEG-1 Audio Layer 3 (MP3) files). ID3 tags refer to a standard format used to add, to MP3 files, information (such as the title of a song, artist, music channel, etc.). That is, ID3 tags include the fields of information presenting, for example, the title of a song, artist, title of the album, year of release, genre, comments, etc. However, it is understood that the fields included in ID3 tags are not limited thereto and may include any information on the corresponding song.

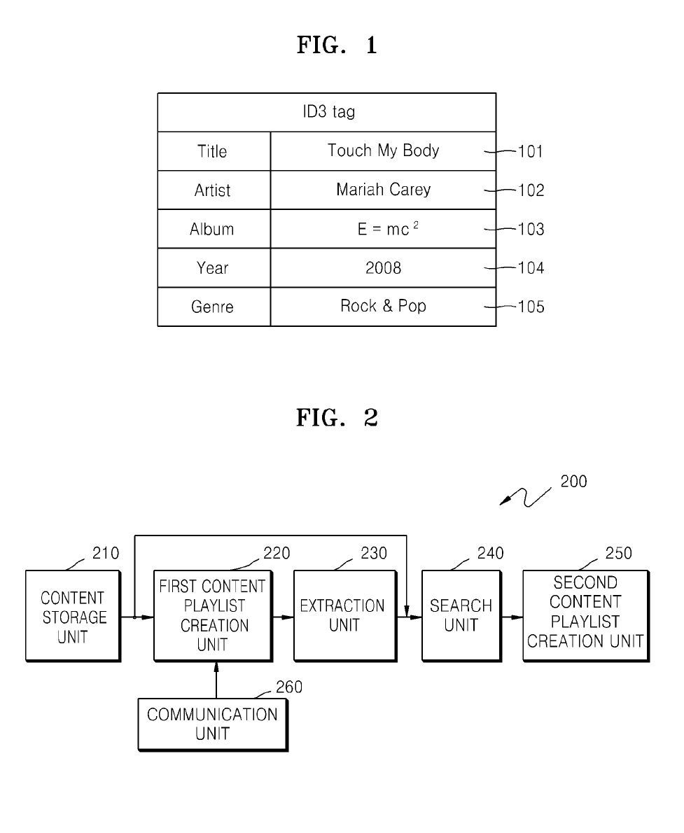

FIG. 1 shows an example of an ID3 tag of an MP3 file. Referring to FIG. 1, an MP3 file entitled “Touch My Body” by the artist “Mariah Carey” includes an ID3 tag with a title field 101, an artist field 102, an album field 103, a year of release field (hereinafter, “year”) 104, and a genre field 105. In particular, the title field 101 indicates “Touch My Body,” the artist field 102 indicates “Mariah Carey” 102, the album field 103 indicates “E=MC²”, the year field 104 indicates “2008,” and the genre field 105 indicates “Rock & Pop.”

FIG. 2 is a block diagram of a content playlist providing apparatus 200 according to an embodiment of the present invention. Referring to FIG. 2, the content playlist providing apparatus 200 includes a content storage unit 210, a first content playlist creation unit 220, an extraction unit 230, a search unit 240, a second content playlist creation unit 250, and a communication unit 260. The content playlist providing apparatus 200 may be included in a content playback apparatus (not shown), such as a mobile phone, a personal digital assistant (PDA), a portable multimedia player (PMP), etc. The content playlist providing apparatus 200 may be implemented using hardware, for example, as separate memory chips or as a single memory chip.

A content playback apparatus is an apparatus to play back moving pictures (i.e., video) and/or audio. Examples of a moving picture playback apparatus include a PMP, a computer, a mobile phone, a PDA, etc. Examples of an audio playback apparatus include an MP3 player, a cassette player, a CD player, a computer, a PMP, a mobile phone, a PDA, etc. However, the examples of content playback apparatuses are not limited to the examples listed above and may include any type of playback apparatus that can playback content.

The content storage unit 210 stores contents. The content storage unit 210 may be included either in or outside of the content playlist providing apparatus 200. Furthermore, the content storage unit 210 may be a volatile memory (such as RAM) or a non-volatile memory (such as ROM, flash memory, or a hard disk drive).

The first content playlist creation unit 220 creates a first content playlist listing content to be played back. That is, items of content to be played back are listed in the first content playlist. In other words, items of content to be played back are listed based on text information, such as the title of a content file. A user of the content playback apparatus creates the first content playlist. Specifically, the user designates content that the user wishes to playback, thereby creating the first content playlist. However, it is understood that aspects of the present invention are not limited thereto. For example, according to other aspects, when the content playlist providing apparatus 200 is connected to a network (such as the Internet), the user can download, via the communication unit 260, and can use a playlist created by another user as the first content playlist. In addition, when the content playlist providing apparatus 200 is connected to a website that provides content online, or when the content playback apparatus is connected to a website that provides content online, the first content playlist may be provided from the website. Also, the first content playlist provided from the website may include content provided from the website that may be displayed separately as a list of purchased content by the user and as a list of non-purchased content.

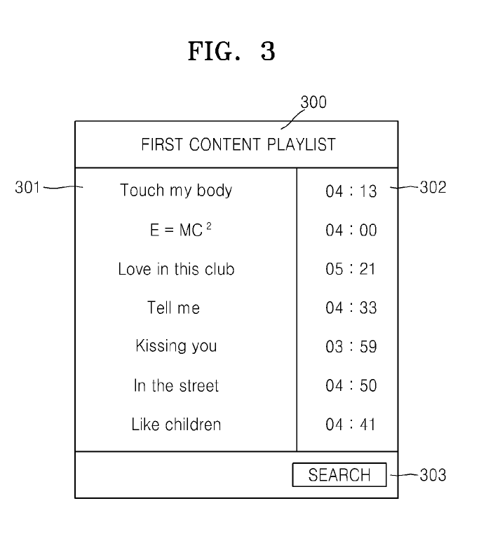

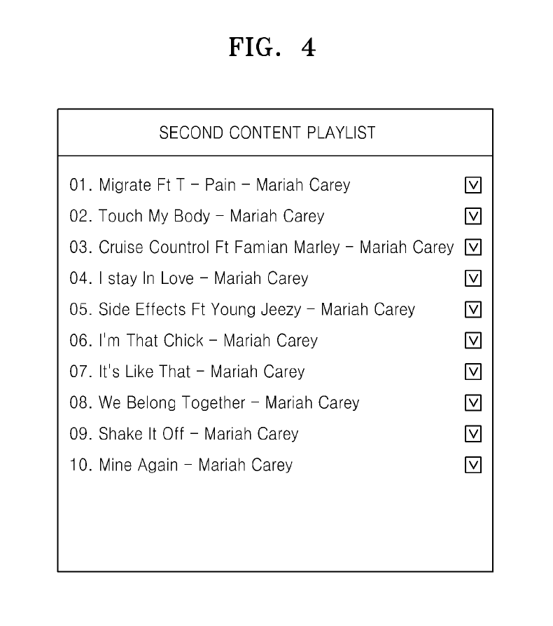

FIG. 3 is a table of a first content playlist 300 according to an embodiment of the present invention. Referring to FIG. 3, the first content playlist 300 listing audio files is shown. However, the content of the first content playlist 300 is not limited to audio files and can include other types of files (such as video files, image files, etc.). The first content playlist 300 displays the names of audio files or the titles of songs 301 and a playback time 302 of each song. For example, the Mariah Carey song entitled “Touch my body” with a playback time of “04:13” (4 minutes and 13 seconds) is displayed. In addition, the first content playlist 300 includes a search button 303 (indicated as “SEARCH” in FIG. 3). When the user selects the search button 303, an expanded content playlist (as illustrated in FIG. 4), which is a second content playlist according to an embodiment of the present invention, is created, as will be described in detail later.

Referring back to FIG. 2, the extraction unit 230 extracts information on the content listed in the first content playlist. For example, field information of the ID3 tag is extracted. Referring to FIG. 1, “Touch My Body” is extracted from the title field 101, “Mariah Carey” from the artist field 102, “E=mc²” from the album field 103, “2008” from the year field 104, and “Rock & Pop” from the genre field 105.

The search unit 240 searches the content stored in the content storage unit 210 based on the extracted field information. If a single item is listed in the first content playlist, the search unit 240 searches the content stored in the content storage unit 210 based on a similarity between the extracted field information and the information of the stored content. For example, if an MP3 file titled “Touch My Body” by Mariah Carey is listed in the first content playlist, the search unit 240 compares the extracted field information (i.e., “Touch My Body” for the title field 101, “Mariah Carey” for the artist field 102, “E=mc²” for the album field 103, “2008” for the year field 104, and “Rock & Pop” for the genre field 105) with the field information of the content stored in the content storage unit 110 and searches for audio with the greatest field information similarity to the extracted field information. If multiple items of content are listed in the first content playlist, the search unit 240 extracts similar points of information among the multiple items of content listed in the first content playlist and searches the stored content based on the similarity between the similar points and the information of the stored content. Initially, the search unit 240 extracts the similar points of information among the multiple items of content listed in the first content playlist (i.e., similar fields with similar entries among the listed multiple items of content). In other words, similar fields with similar entries, among the listed multiple items of content, are extracted. For example, assuming that three audio files are listed in the first content playlist 300, Table 1 shows field information of each item of content:

TABLE 1

| | ID3 tag 1 | ID3 tag 2 | ID3 tag 3 |
|---|---|---|---|
| Title | Touch my body | Migrate Ft T-Pain | We Belong Together |
| Artist | Mariah Carey | Mariah Carey | Mariah Carey |
| Album | E = MC² | E = MC² | The Emancipation Of Mimi |
| Year | 2008 | 2008 | 2006 |
| Genre | Rock & Pop | Rock & Pop | Rock & Pop |

In Table 1, the three audio files have two pieces of similar field information (specifically, “Mariah Carey” and “Rock & Pop,” for the artist and genre fields, respectively). Then, the search unit 240 searches the content stored in the content storage unit 210 based on the extracted similar field information. The search unit 240 searches all of the content stored in the content storage unit 210 for audio files with the field information that is similar to the two pieces of extracted field information. Then, the search unit 240 searches for audio files with the field information that is similar to one of the two pieces of the extracted field information. However, it is understood that aspects of the present invention are not limited to these examples. Various commonly known search engine algorithms can be applied in aspects of the present invention. For example, for the year field, although this year field information is not the same among the three audio files in Table 1, an algorithm to search for songs released between the year 2008 and the year 2006 using approximate searching keywords or ranking the songs in the order of similarity to the year 2008 can be applied. In addition, for other fields, a search engine algorithm using the similarity between keywords can be used.

The second content playlist creation unit 250 creates a second content playlist listing the found items of content. The second content playlist creation unit 250 may create the second content playlist by arranging the found items of content in a priority order of highest similarity to the extracted field information. In Table 1, since the three audio files have two pieces of similar field information (i.e., “Mariah Carey” and “Rock & Pop” for the artist and genre fields, respectively), content with the field information of both “Mariah Carey” and “Rock & Pop” have the highest priority. Content with the field information of either “Mariah Carey” or “Rock & Pop” is ranked next highest. However, it is understood that the order of priority is not limited to this example and may be arbitrarily set by the user. In addition, the user can also determine the order of priority for the items of content listed in the second content playlist.

FIG. 4 is a table of the second content playlist according to an embodiment of the present invention. Referring to FIG. 4, the second content playlist is created such that content with the field information of “Mariah Carey” and “Rock & Pop” is ranked with higher priority. The user can rank the found results from 1st to 100th based on combinations of different priority orders. Alternatively, the user can specify and use some of the found results to create the second content playlist.

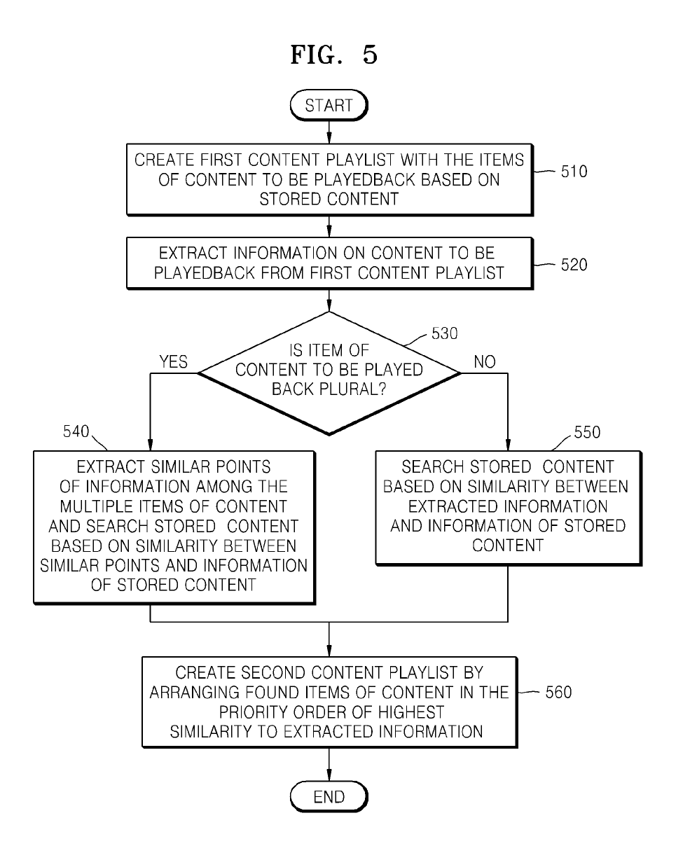

FIG. 5 is a flowchart of a content playlist providing method according to an embodiment of the present invention. Referring to FIG. 5, a user of the content playback apparatus creates a first content playlist with the items of content to be played back based on the stored content in operation 510. For example, the user designates content that the user wishes to playback, thereby creating the first content playlist. However, it is understood that aspects of the present invention are not limited thereto. For example, according to other aspects, when the content playback apparatus or a content playlist providing apparatus is connected online via the web, a playlist created by another user can be downloaded and used as the first content playlist. Also, when the content playback apparatus or a content playlist providing apparatus is connected to a website that provides content online, the first playlist can be created based on a list of content provided from the website. That is, the first content playlist provided from the website includes content provided by the website. The content provided by the website may be displayed separately as a list of purchased content by the user and as a list of non-purchased content.

Information on content to be played back is extracted from the first content playlist in operation 520. For example, if the content is an audio file (for example, an MP3 file), field information is extracted from the file's ID3 tag. The first content playlist may be newly created, or an existing playlist may be used as the first content playlist.

Then, it is determined whether a single item of content or a plurality of items of content is to be played back in operation 530. If a plurality of items of content is listed in the first content playlist, the method proceeds to operation 540. Otherwise, if a single item of content is listed in the first content playlist, the process proceeds to operation 550.

If a plurality of items of content is listed in the first content playlist, similar points of information among the multiple items of content are extracted, and the stored content is searched based on a similarity between the similar points of information and the information of the stored content in operation 540. Initially, the similar points of information among the plurality of items of content listed in the first content playlist are extracted. In other words, similar field information, among the listed plurality of items of content, is extracted. Next, the stored content is searched based on the extracted similar field information. For example, when the first content playlist includes three items of content and four fields of the items of content have similar field information, content is searched among the stored content in a priority order of the content with the similar field information corresponding to all of the four fields, the content with the similar field information corresponding to three of the four fields, the content with the similar field information corresponding to two of the four fields, and the content with the similar field information corresponding to one of the four fields.

If a single item is listed in the first content playlist, the stored content is searched based on a similarity between the extracted field information and the information of the stored content in operation 550. For example, the field information of the content listed in the first content playlist is compared with the information of the stored content in order to search for content with the greatest field information similarity to the extracted field information of the content in the first content playlist.

A second content playlist that lists the found items of content is created, in operation 560, by arranging the found items of content (operation 540 or 550) in the priority order of highest similarity to the extracted field information. However, it is understood that aspects of the present invention are not limited thereto. For example, the priority order may be arbitrarily set by the user. In addition, the user can also determine the priority order for the items of content listed in the second content playlist.

According to aspects of the present invention, content that the user wishes to play back can be predicted based on a playlist created by the user, and an expanded playlist can be created based on the predicted content. Thus, the user can create a new, expanded playlist without designating all the content that the user wishes to playback.

Aspects of the present invention described above can also be embodied as computer-readable codes on a computer-readable recording medium. The computer-readable recording medium is any data storage device that can store data, which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, functional programs, codes, and code segments for accomplishing aspects of the present invention can be easily construed by programmers skilled in the art to which aspects of the present invention pertain. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A content playlist providing method in a content playback apparatus storing content, the method comprising:
extracting information of content to be played back from a first content playlist listing the content to be played back;
searching stored content based on the extracted information; and
creating a second content playlist listing content, from among the stored content, found in the searching.

2. The method as claimed in claim 1, further comprising:
creating a first content playlist listing the content to be played back, based on the stored content.

3. The method as claimed in claim 1, wherein:
the content to be played back is an audio file; and
the information of the content to be played back is a name of the audio file and/or ID3 tag information.

4. The method as claimed in claim 3, wherein the ID3 tag information comprises a title, an artist, an album, a year of release, and/or a genre.

5. The method as claimed in claim 1, wherein:
one item of content is listed in the first content playlist; and
the searching of the stored content comprises searching the stored content based on a similarity between the extracted information of the one item of content listed in the first content playlist and information of the stored content.

6. The method as claimed in claim 1, wherein:
a plurality of items of content is listed in the first content playlist;
the extracting of the information of the content to be played back comprises extracting similar points of information of the plurality of items of content listed in the first content playlist; and
the searching of the stored content comprises
searching the stored content based on a similarity between the similar points of information and information of the stored content.

7. The method as claimed in claim 5, wherein the creating of the second content playlist comprises creating the second content playlist by arranging the found content in a priority order of highest similarity.

8. The method as claimed in claim 5, wherein the creating of the second content playlist comprises creating the second content playlist by arranging the found content in a priority order that is selectively set by a user.

9. The method as claimed in claim 6, wherein the creating of the second content playlist comprises creating the second content playlist by arranging the found content in a priority order of highest similarity.

10. The method as claimed in claim 6, wherein the creating of the second content playlist comprises creating the second content playlist by arranging the found content in a priority order that is selectively set by a user.

11. The method as claimed in claim 1, further comprising downloading the first content playlist through a communication network.

12. The method as claimed in claim 1, wherein:
the content playback apparatus is connected to a website that provides content online; and
the first content playlist is provided from the website.

13. A computer-readable recording medium storing a program for executing a content playlist providing method in a content playback apparatus storing content, the method comprising:
extracting information of content to be played back from a first content playlist listing the content to be played back; searching stored content based on the extracted information; and
creating a second content playlist listing content, from among the stored content, found in the searching.

14. A content playlist providing apparatus comprising:
an extraction unit to extract information of content to be played back from a first content playlist listing the content to be played back;
a search unit to search the content stored in the storage unit based on the extracted information; and
a second content playlist creation unit to create a second content playlist listing content, from among the stored content, found in the searching.

15. The apparatus as claimed in claim 14, further comprising:
a storage unit to store content; and
a first content playlist creation unit to create a first content playlist listing the content to be played back, based on the content stored in the storage unit.

16. The apparatus as claimed in claim 14, wherein:
the content to be played back is an audio file; and
the information of the content to be played back is a name of the audio file and/or ID3 tag information.

17. The apparatus as claimed in claim 16, wherein the ID3 tag information comprises a title, an artist, an album, a year of release, and/or a genre.

18. The apparatus as claimed in claim 14, wherein one item of content is listed in the first content playlist; and
the search unit searches the content stored in the storage unit based on a similarity between the extracted information of the one item of content listed in the first content playlist and information of the stored content.

19. The apparatus as claimed in claim 14, wherein:
a plurality of items of content is listed in the first content playlist;
the extraction unit extracts similar pints of information of the plurality of items of content listed in the first content playlist; and
the search unit searches the content stored in the storage unit based on a similarity between the similar points of information and information of the stored content.

20. The apparatus as claimed in claim 18, wherein the second content playlist creation unit creates the second content playlist by arranging the found content in a priority order of highest similarity.

21. The apparatus as claimed in claim 18, wherein the second content playlist creation unit creates the second content playlist by arranging the found content in a priority order that is selectively set by a user.

22. The apparatus as claimed in claim 19, wherein the second content playlist creation unit creates the second content playlist by arranging the found content in a priority order of highest similarity.

23. The apparatus as claimed in claim 19, wherein the second content playlist creation unit creates the second content playlist by arranging the found content in a priority order that is selectively set by a user.

24. The apparatus as claimed in claim 14, further comprising a communication unit to download the first content playlist through a communication network.

25. The apparatus as claimed in claim 24, wherein:
the content playlist providing apparatus is connected to a website that provides content online; and
the first content playlist is provided from the website.
